(19) United States
(12) Patent Application Publication
(10) Pub. No.: US 2014/0187732 A1
(43) Pub. Date: Jul. 3, 2014

(54) GROUT AND MORTAR COMPOSITIONS

(71) Applicant: PosiBond LLC, Marietta, GA (US)

(72) Inventors: Mark Rule, Roswell, GA (US); Harry Harshaw, Marietta, GA (US)

(21) Appl. No.: 14/070,052

(22) Filed: Nov. 1, 2013

Related U.S. Application Data
(60) Provisional application No. 61/748,313, filed on Jan. 2, 2013.

(51) Int. Cl. C04B 26/10

(52) U.S. Cl. CPC C04B 26/10
USPC 528/12; 252/183.13

(57) ABSTRACT

This invention provides compositions comprising reactive inorganic fillers in a cross-linked organosiloxane matrix and methods to produce the same. These compositions are useful as stain and acid resistant grouts and mortar.

### CROSS-REFERENCE TO RELATED APPLICATION

This application claims the benefit of priority of U.S. Provisional Patent Application Ser. No. 61/748,313 filed on Jan. 2, 2013 hereby incorporated herein by reference in its entirety.

### FIELD OF THE INVENTION

This invention relates to mortar and grout compositions comprising reactive inorganic fillers in a cross-linked organosiloxane matrix.

### BACKGROUND OF THE INVENTION

Granite, marble, slate, ceramic, brick, and porcelain surfaces represent a large amount of floor, countertop, and wall area in both residential and commercial buildings, with over 2 billion square feet installed in the United States each year. These products are often selected for use in areas which will see exposure to liquid water on a regular basis, such as in kitchens, baths, and on exterior structures. Almost without exception, these surfaces are installed by adhering pre-cut tiles or stones to a wall or floor, with the spacing between the pieces subsequently filled with a mortar or a grout. Depending on the material, the tiles or stones themselves exhibit varying degrees of water porosity, ranging from relatively impervious in the case of porcelain tile to extremely porous in the case of marble.

The most commonly used grouting materials are cementitious in nature, and are highly porous to liquid water and are very susceptible to staining. Consequently, these grouts are often treated with various additives to reduce their moisture permeability and to enhance their stain resistance. These additives typically consist of an organic or semi-aqueous dispersion of a silicone or fluoroacrylic copolymer, which are applied after construction is complete, and which on evaporation of the solvent deposits a water repellent polymer film on the cementitious surfaces. However, in demanding applications cementitious grouts are not considered adequate. In those instances, polymeric grouts may be employed. These polymeric grouts typically comprise a cross-linked organic polymer filled with one or more inorganic additives.

Commercially available polymeric grouts may be urethane based, epoxy based, or acrylic based. Of these, epoxy-based grouts enjoy the greatest success, due to the higher strength and stain resistance exhibited by such materials. However, even epoxy-based grouts have marked deficiencies that limit their usefulness. Those deficiencies include difficulty in application clean-up; limited pot life; high odor; and most importantly, susceptibility to chemical attack and degradation by commonly used cleaners, especially enzymatic cleaners.

### SUMMARY OF THE INVENTION

Concordant and congruous with the present invention, a siloxane-based grouting composition has surprisingly been discovered.

The present invention discloses a method and compositions suitable for grouting stone, ceramic, brick, and porcelain materials that avoid the drawbacks of prior-art methods and products. In particular, compositions of the present invention comprise cross-linked organosiloxanes reactively bonded to inorganic fillers. These compositions exhibit high hydrophobicity, high resistance to staining, excellent adhesion to stone, ceramic, brick, and porcelain; high resistance to acids; and imperviousness to the action of enzymatic cleaners. The method of the present invention comprises providing at least one organotrialkoxysilane, at least one acidic or basic catalyst, and at least one reactive inorganic filler, mixing these components to provide a fluid composition, applying said composition to surfaces to be grouted, and allowing the resultant composition to cure in the presence of moisture.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Organosiloxanes of the present invention can be characterized as having the general formula:

R—Si(O—X)₃

Where R— is a hydrocarbon fragment and the compound possesses a carbon-silicon bond. The hydrocarbon fragment R— may be comprised of alkyl, cycloalkyl, or aryl moieties, and may be optionally substituted with other functional groups including but not limited to hydroxyl, carboxyl, chloro, bromo, fluoro, or amino. X— is Si, optionally bonded to additional —OH, —OR, or —OSi groups. In the present invention, R— is preferably alkyl or aryl and more preferably methyl, ethyl, or phenyl.

Organotrialkoxysilanes are commonly available precursors to organosiloxanes. Organotrialkoxysilanes and especially alkyltrialkoxysilanes and aryltrialkoxysilanes possess a number of beneficial characteristics. First, these organotrialkoxysilanes are liquids commercially available in large quantities. Second, if desired, they can be partially prehydrolyzed under mild acid or alkaline conditions to form solutions of non-volatile oligomeric organosiloxanes and alcohol. In the absence of additional water, these organosiloxane solutions are stable, but on addition of water undergo further hydrolysis and condensation to form cross-linked resins possessing Si—O—Si linkages. Third, in addition to reacting with water, organotrialkoxysilanes can react with inorganic fillers possessing reactive surface groups such as Si—OH, Al—OH, and Ti—OH. Fourth, cross-linked organosiloxanes are hydrophobic and exhibit exceptional resistance to staining. Fifth, while films of cross-linked organosiloxanes possess a degree of flexibility and are often employed as abrasion-resistant coatings for plastics, when bonded to inorganic fillers possessing reactive surface groups hard, rigid, chemically resistant and adherent compositions are obtained. Sixth, the initial hydrolysis product of organotrialkoxysilanes is the corresponding neutral, volatile alcohol. Preferred alkoxy groups include methoxy, ethoxy, propoxy, and isopropoxy. Especially preferred is ethoxy, since the corresponding hydrolysis product is relatively nontoxic ethanol.

Partially hydrolyzed oligomeric organosiloxanes of the present invention can be prepared by any number of techniques, such as described by Liebler in U.S. Pat. No. 4,455,403. The weight ratio of organotrialkoxysilane to water is preferably in the range of about 80:20 to about 97:3, and may be in the range of about 85:15 to about 93:7. While either basic or acidic catalysts may be employed, acidic catalysts are preferred. Suitable acidic catalysts include but are not limited to hydrochloric acid, phosphoric acid, alkylphosphoric acids, phosphonic acids, and carboxylic acids. The amount of catalyst employed is not critical, and typically can range from about 0.01% to about 10% of the total reaction mixture, depending on the desired reaction rate. The partially hydrolyzed oligomeric organosiloxane/alcohol mixture obtained is shelf-stable, and can be used directly as the liquid portion in preparing grouts. Optionally, the reaction byproduct alcohol may be removed by from the partially hydrolyzed oligomeric organosiloxane by distillation or evaporation. Enhanced storage stability of the oligomeric organosiloxane is obtained when the organotrialkoxysilane to water ratio is less than about 1:1 on a mole basis. Prehydrolysis of an organotrialkoxysilane is preferred when the starting organotrialkoxysilane is relatively volatile, when the final formed shape is relatively thick, when the ambient humidity is relatively low, or when the catalyst is relatively inactive.

Acidic catalysts suitable for compositions of the present invention include but are not limited to carboxylic acids, hydrogen halides, sulfonic acids, phosphoric acids, and phosphonic acids. Of these, alkylphosphoric acid esters and alkylphosphonic acids are preferred, due to their high acidity, non-volatility, and relatively non-corrosive nature. Suitable concentrations of acidic catalyst range from about 0.01% to about 15% and preferably from about 1% to about 10% based on the weight of the organotrialkoxysilane.

Basic catalysts suitable for compositions of the present invention include but are not limited to amines, carboxylic acid metal salts, metal carbonates, metal bicarbonates, and metal hydroxides. Preferred basic catalysts include amino-functionalized organotrialkoxysilanes. A particularly preferred basic catalyst is aminopropyltriethoxysilane. Suitable concentrations of basic catalyst range from about 0.01% to about 25%, and may be from about 1% to about 10% based on the weight of the organotrialkoxysilane.

The reactive inorganic fillers of the present invention may be any inorganic particulate with suitable surface active groups, especially surface M—OH groups, where M may be Si, Al, Ti, Fe, Zr, or other metallic or metalloid elements. Such materials include but are not limited to sand, silica, titanium dioxide, alumina, silica-aluminates, clays, feldspars, and amorphous glasses. Preferred inorganic fillers are particulate silicates, and especially preferred are non-alkaline silicates such as sand and silica flour. While not bound to any particular theory, we believe that the presence of M—O—H groups facilitates bonding between the filler and the organosiloxane matrix.

In order to maximize packing density of the inorganic filler in an organosiloxane/inorganic filler composition, it is desirable for the inorganic filler to have a mixture of particle sizes. It is preferred that the ratio of the average particle size between the small particles and large particles to be less than about 0.4, and may be less than about 0.2. Maximizing packing density of the inorganic filler both minimizes the amount of organotrialkoxysilane required as well as minimizes the particle-to-particle distance that the organosiloxane matrix needs to bridge. The weight ratio of large particles to small particles is not particularly crucial, but preferred ratios are from about 90:10 to about 50:50, and may be from about 70:30 to about 60:40. In one embodiment, the average particle size of the large particles is less than about 1000 microns and the average particle size of the small particles is less than about 75 microns. In another preferred embodiment, the average particle size of the large particles is less than about 600 microns and the average particle size of the small particles is less than about 45 microns.

In addition to organotrialkoxysilanes it is anticipated that dialkyldialkoxysilanes and tetraalkoxysilanes may also be present. Incorporation of dialkyldialkoxysilanes and/or tetralkoxysilanes into the organotrialkoxysilane fluid may be used as a means to modify the mechanical properties of the resulting grout by increasing the flexibility or rigidity as desired.

The order of mixing of organotrialkoxysilane, catalyst, and reactive inorganic filler is not particularly critical. Thus, the catalyst and organotrialkoxysilane may be pre-blended, optionally with sufficient water to achieve partial hydrolysis, and the resultant mixture subsequently mixed with the reactive inorganic filler. Alternatively, the catalyst may be pre-blended with the reactive inorganic filler, with the organotrialkoxysilane added afterward. Optionally, all components may be mixed together and stored in a moisture-free environment. Such mixtures will be stable until they are formed into a final shape and exposed to moisture.

The ratio of organotrialkoxysilane to reactive inorganic filler is not especially critical, and will generally be determined by the amount needed to achieve an acceptable fluidity. In general however, weight ratios of about 15-40% liquid to solids should be sufficient, and more commonly weight ratios of about 18-25% can be expected.

In the method of the present invention, the fluid mixture of optionally prehydrolyzed organotrialkoxysilane, catalyst, and reactive inorganic filler is formed into a final shape and exposed to moisture and allowed to cure. The time required for the fluid grout to harden will depend somewhat on temperature, humidity, catalyst, and thickness of the article. While elevated temperatures and humidities will accelerate cross-linking, they are not essential to the practice of this invention. In general, under ambient conditions cure will be largely complete within 24 to 48 hours, although cure times greater than one week may be necessary for thick articles. Optionally, cure rates may be accelerated by post-treatment of the final shape with liquid water or water vapor. After curing is complete, the resultant article is strong, resilient, hydrophobic, highly resistant to attack by acids or cleaners, and highly resistant to staining by foods, beverages, or food dyes.

While cross-linked organosiloxanes have been disclosed as compositions for rendering concrete and masonry surfaces water repellent (U.S. Pat. No. 5,112,393), and as compositions for rendering wood composition board surfaces water repellent (U.S. Pat. No. 6,572,978), these applications involve applying an organotrialkoxylsilane to the surface of preformed masonry or wood articles, followed by hydrolysis to generate water repellent coatings. In contrast, in the present invention the cross-linked organosiloxane is the matrix material binding powdered inorganic filler particles together. The organosiloxane/inorganic filler composition of the present invention are prepared by preparing a fluid mixture comprising a fluid organotrialkoxysilane or partially hydrolyzed organotrialkoxysilane, an acidic or basic catalyst, and a reactive inorganic filler, and subsequently forming said fluid mixture into the shape of the final article prior to curing and crosslinking of the organosiloxane matrix.

Applications for compositions of the present invention include but are not limited to: as a grout for tile, stone, and brick; as a water-repellent mortar skim coat for cement, wood, metal, and drywall surfaces; as a thin-coat adhesive layer to bond tile to flooring or walls; as a caulk for filling voids, especially on tile or at tile/metal interfaces; and as a water and stain resistant plaster.

The method of the present invention comprises:
1. Providing a organotrialkoxysilane fluid (which may optionally be partially hydrolyzed);
2. Providing an acidic or basic catalyst;
3. Providing a reactive inorganic filler;
4. Mixing an optionally partially hydrolyzed organotrialkoxysilane with the at least one reactive inorganic filler and catalyst so that the particles of filler are wetted by the organotrialkoxysilane and a fluid mass is obtained;
5. Forming the fluid mass into the desired shape;
6. Allowing the fluid mass to harden and cure into the final article in the presence of moisture.

The following examples demonstrate the practice of this invention. Concentrations are all expressed as weight percent unless otherwise noted.

### EXAMPLE 1

400 grams of methyltriethoxysilane was placed in a 1L beaker, and 100 grams of distilled water and 5 grams of glacial acetic acid was added. The mixture was stirred rapidly with a magnetic stirrer until a homogeneous solution was obtained. Stirring was continued for an additional 30 minutes, The product was then transferred to a 1 pint HDPE container and sealed.

### EXAMPLE 2

A soda-lime wine glass was pulverized and sieved to pass a 120 mesh screen. 50 grams of the sieved material was mixed with 14 grams of the solution from Example 1 to produce a fluid mass. After allowing to standing for 10 minutes, the fluid mass was mixed again and poured into a plastic petri dish 3.375 inches in diameter and 0.25 inches deep. After 7 days, the cured grout was removed from the petri dish. The resultant grout disk was soaked in red wine for 24 hours, then removed and rinsed briefly with running water. There was no staining of the disk. Immersion of the same disk in 31% HCl (commercial muriatic acid) for 20 minutes had no visible effect on the disk. Immersion of the same disk in neat 2-ethylhexanoic acid for 2 weeks had no visible effect.

### EXAMPLE 3

A soda-lime wine bottle was pulverized and sieved to pass a 120 mesh screen. 50 grams of the sieved material was mixed with 1.2 grams of TiO₂ powder, and this composition was then mixed with 14 grams of the solution from Example 1 to produce a viscous grout. After allowing to stand for 10 minutes, the grout was mixed again and troweled into the grout lines of a tile board composed of 2″×2″ travertine tiles spaced ⅛″ inches apart. Within 30 minutes of filling the grout lines, residual grout was wiped off the surface of the tiles and the tiles with a wet sponge; the tile board was then set aside and allowed to cure. After 12 hours the grout was still slightly soft, as evidenced by indentation by a knife blade. After 7 days the grout had fully cured, exhibited no shrinkage, and had excellent adhesion to the tiles. Exposure to red wine for 2 hours followed by a water rinse resulted in significant staining of the travertine tile; in contrast, the cured grout exhibited no staining.

### EXAMPLE 4

16.0 grams of 30 mesh soda-lime glass and 9.0 grams of 325 mesh soda-lime glass were mixed in a plastic cup until a homogeneous dry mix was obtained. 5.0 grams of the solution from Example 1 was added and stirred until a viscous grout was obtained. The resultant grout was poured onto a sheet of aluminum foil to produce a disk approximately 3 inches in diameter. After curing for 4 days, water absorbency was tested by a) weighing the disk, b) immersing the disk in tap water for 1 hour, and c) removing the disk, wiping dry, and reweighing. Moisture sorption was <1.0%.

### EXAMPLE 5

16.0 grams of 80 mesh soda-lime glass and 9.0 grams of 325 mesh soda-lime glass were mixed in a plastic cup until a homogeneous dry mix was obtained. 6.5 grams of the solution from Example 1 was added and stirred until a viscous grout was obtained. The resultant grout was poured onto a sheet of aluminum foil to produce a disk approximately 3 inches in diameter. After curing for 4 days, water absorbency was tested by a) weighing the disk, b) immersing the disk in tap water for 24 hours, and c) removing the disk, wiping dry, and reweighing. Moisture sorption was 1.05%.

### EXAMPLE 6

32.0 grams of 30 mesh soda-lime and 18 grams 325 mesh soda-lime glass was mixed in a plastic cup until a homogenous dry mix was obtained. 10 grams of solution from Example 1 was added and mixed until a viscous grout was obtained. The mixture was allowed to stand for 10 minutes, then was remixed and poured into a 3.375″ diameter×0.375 deep plastic petri dish. After 7 days, the cured disk was removed. The cured disk was impervious to staining by red wine, ketchup, mustard, and coffee (2 hour exposure); was unaffected by lemon juice or muriatic acid (2 hour exposure); and exhibited a flexural strength greater than an equivalent sized cementitious grout disk.

### EXAMPLE 7

To 60.0 grams of methyltriethoxysilane was added 5.0 grams distilled water containing 1% phosphoric acid. The resulting mixture was stirred at room temperature until reaction was complete, as evidenced by the solution becoming clear and the cessation of heat generation. The product was then transferred to a 4 oz. plastic bottle and sealed.

### EXAMPLE 8

In a 3 oz. plastic cup a mixture consisting of 6.4 grams silica sand, 3.6 grams silica flour (average particle size 45 microns), 0.2 grams titanium dioxide, and 0.1 grams sulfamic acid was prepared. To this mixture was added 1.8 grams of the solution prepared in Example 7. After stirring and allowing to stand for 5 minutes, the mixture was re-stirred and poured into a plastic petri dish. After 24 hours the resulting grout was hard, and after 48 hours was strong, water resistant, and stain resistant.

### EXAMPLE 9

In a 5 oz. plastic cup a mixture consisting of 16 grams silica sand, 9 grams silica flour (average particle size 45 microns), 0.5 grams titanium dioxide, and 0.25 grams carboxyethyl phosphonic acid was prepared. To this mixture was added 4.5 grams of the solution prepared in Example 7. After stirring and allowing to stand for 5 minutes, the mixture was re-stirred and installed in a ½″ grout line between travertine tiles. After 30 minutes, the grout line was cleaned using a dampened sponge. After 24 hours the resulting grout was hard, and after 48 hours was strong, water resistant, and stain resistant.

### EXAMPLE 10

In a 3 oz. plastic cup was placed 2.0 grams of phenyltriethoxysilane and 0.1 grams of pentylphosphoric acid. After stirring, 10.3 grams of a powder silicate mixture comprising 6.0 grams silica sand, 4.0 grams silica flour (average particle size 45 microns), 0.1 grams corn starch, and 0.2 grams titanium dioxide was added. The fluid mix was allowed to stand for 5 minutes, then was remixed and placed into a ⅜″ wide grout line between ceramic tiles. After an additional 5 minutes, excess grout was wiped away using a damp sponge. After 12 hours, the grout was hard and could not be indented with a putty knife. After 48 hours, stain resistance was tested using red wine. A drop of red wine on the grout remained unabsorbed after 30 minutes, and the wine could be wiped away with no residual staining using a damp sponge.

### EXAMPLE 11

In a 3 oz. plastic cup was placed 1.6 grams of phenyltriethoxysilane and 0.4 grams of aminopropyltriethoxysilane. After stirring, 10.3 grams of a powder silicate mixture comprising 6.0 grams silica sand, 4.0 grams silica flour (average particle size 45 microns), 0.1 grams corn starch, and 0.2 grams titanium dioxide was added. The fluid mix was allowed to stand for 5 minutes, then was remixed and placed into a ⅜″ wide grout line between travertine marble tiles. After an additional 5 minutes, excess grout was wiped away using a damp sponge. After 72 hours, the grout was hard and could not be indented with a putty knife. After 1 week, stain resistance was tested using red wine. A drop of red wine on the grout remained unabsorbed after 30 minutes, and the wine could be wiped away with no residual staining using a damp sponge.

### COMPARATIVE EXAMPLE 12

25 grams of Bonsai Prospec® sanded white grout powder was mixed with 5 grams of water to form a viscous grout mixture. After standing for 10 minutes, the mixture was poured onto a sheet of aluminum foil to produce a disk approximately 3 inches in diameter. After curing for 4 days, water absorbency was tested by a) weighing the disk, b) immersing the disk in tap water for 24 hours, and c) removing the disk, wiping dry, and reweighing. Moisture sorption was >9%.

### COMPARATIVE EXAMPLE 13

50 grams of Bonsal Prospec® sanded white grout powder was mixed with 10 grams of water to form a viscous grout mixture. After standing for 10 minutes, the mixture was poured into a 3,375″ diameter×0.375 deep plastic petri dish. After curing for 7 days, stain resistance was tested by spotting red wine onto the disk. After 1 hour, the wine had completely absorbed, leaving a black spot that could not be removed even after scrubbing with detergent.

### COMPARATIVE EXAMPLE 14

50 grams of Laticrete Spectralock® epoxy grout was prepared as per manufacturer's instructions and poured into a 3.375″ diameter×0.375 deep plastic petri dish. After curing for 7 days, stain resistance was tested by spotting red wine onto the disk. After 1 hour, the residual wine was rinsed off. There remained a visible stain that could not be removed even with scrubbing with detergent. Immersion of the disk in neat 2-ethylhexanoic acid for 2 weeks resulted severe degradation of the disk.

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

From the foregoing description, one ordinarily skilled in the art can easily ascertain the essential characteristics of this invention and, without departing from the spirit and scope thereof, can make various changes and modifications to the invention to adapt it to various usages and conditions.

We claim:

1. A composition comprising a cross-linked organosiloxane and at least one reactive inorganic filler.

2. The composition of claim 1, wherein the at least one reactive inorganic filler includes a M—OH group, where M may be Si, Al, Ti, Fe, Zr, other metallic elements, or metalloid elements.

3. The composition of claim 2, wherein the reactive inorganic filler is a silicate.

4. The composition of claim 1, wherein particles of the reactive inorganic filler have more than one particle size.

5. The composition of claim 4, wherein a ratio of large particle sizes to small particle sizes of the reactive inorganic filler is less than about 0.4.

6. The composition of claim 1, further comprising an acidic catalyst.

7. The composition of claim 1, wherein the organosiloxane comprises an alkylsiloxane.

8. The composition of claim 1, wherein the organosiloxane comprises a phenylsiloxane.

9. The composition of claim 1, wherein the reactive inorganic filler includes at least one organic pigment or inorganic pigment.

10. The composition of claim 1, wherein the organosiloxane is represented by the formula R—Si(O—X)₃ where R— is a hydrocarbon fragment possessing a carbon-silicon bond and where X— is Si bonded to one of an —OH, —OR, and —OSi group.

11. A composition comprising a cross-linked organosiloxane represented by the formula R—Si(O—X)₃ where R— is a hydrocarbon fragment possessing a carbon-silicon bond and where X— is Si bonded to one of an —OH, —OR, and —OSi group, and at least one reactive inorganic filler including a M-OH group, where M may be Si, Al, Ti, Fe, Zr, other metallic elements, or metalloid elements.

12. The composition of claim 11, wherein the reactive inorganic filler is a silicate.

13. The composition of claim 11, wherein particles of the reactive inorganic filler have more than one particle size with a ratio of large particle sizes to small particle sizes less than about 0.4.

14. The composition of claim 11, further comprising an acidic catalyst.

15. The composition of claim 11, wherein the organosiloxane is one of an alkylsiloxane and a phenylsiloxane.

16. The composition of claim 11, wherein the reactive inorganic filler includes at least one organic or inorganic pigment.

17. A method to prepare a composition comprising a cross-linked organosiloxane and at least one reactive inorganic filler that comprises the steps:
a. Providing an optionally partially hydrolyzed organotrialkylsilane;
b. Providing an acidic or basic catalyst;
c. Providing a reactive inorganic filler;
d. Mixing the organotrialkoxysilane with the catalyst and the reactive inorganic filler so that the particles of filler are wetted by the optionally partially hydrolyzed organotrialkoxysilane to obtain a fluid mass;
e. Forming the fluid mass into a desired shape;
f. Exposing the shaped mass to moisture; and
g. Allowing the fluid mass to harden and cure into the final article.

18. The composition of claim 1, wherein the composition comprises the reaction product of at least one partially hydrolyzed organotrialkoxysilane and at least one particulate silicate.

19. The composition of claim 1, wherein the at least one reactive inorganic filler comprises greater than about 60 wt % of the total weight of the cured composition.

20. A grout composition, comprising at least about 60 wt % particulate silica in a cross-linked organosiloxane matrix.
